(19) United States
(12) Patent Application Publication
(10) Pub. No.: US 2016/0034762 A1
(43) Pub. Date: Feb. 4, 2016

(54) METHOD AND DEVICE FOR MAPPING SENSOR LOCATION AND EVENT OPERATION USING MONITORING DEVICE

(71) Applicant: Samsung Electronics Co., Ltd., Gyeonggi-do (KR)

(72) Inventors: Younseog CHANG, Gyeonggi-do (KR); Dongik LEE, Gyeonggi-do (KR); Apoorv KANSAL, Gyeonggi-do (KR)

(73) Assignee: Samsung Electronics Co., Ltd.

(21) Appl. No.: 14/812,534

(22) Filed: Jul. 29, 2015

(30) Foreign Application Priority Data
Jul. 29, 2014 (KR) 10-2014-0096196

(51) Int. Cl. G06K 9/00; G06T 7/00; G06K 9/62; G06T 19/00

(52) U.S. Cl. CPC G06K 9/00671; G06T 19/006; G06T 7/004; G06K 9/6201; G06T 2207/10016; G06T 2207/30232

(57) ABSTRACT

A method, device and chipset for a monitoring device connectable with a sensor device monitoring surroundings thereof. The method includes searching for a sensor device, acquiring images for the surroundings of the monitoring device, registering location information corresponding to the sensor device, discovered through searching, using the images, and registering monitoring information including an operation performed in response to an event occuring in the discovered sensor device. The device includes a camera configured to acquire an image; a communication unit configured to transmit/receive a signal in a wired or wireless manner; a storage unit configured to register information; and a controller configured to search for a sensor device, acquire images for the surroundings of the monitoring device, register location information corresponding to the sensor device, discovered through searching, using the images, and register monitoring information including an operation performed in response to an event occurring in the discovered sensor device.

### PRIORITY

This application claims priority under 35 U.S.C. §119(a) to a Korean Patent Application filed on July 29, 2014 in the Korean Intellectual Property Office and assigned Serial No. 10-2014-0096196, the entire content of which is incorporated herein by reference.

### BACKGROUND

1. Field of the Disclosure

The present disclosure relates generally to a method and device for mapping a sensor location and an event operation using a monitoring device and, more particularly, to a method and device for inputting a monitoring location and a monitoring operation at an occurrence of an event using an image captured by a monitoring device.

2. Description of the Related Art

When a sensor senses a preset input, a monitoring device receives the input from the sensor and performs a predetermined operation. For example, the monitoring device monitors a location relating to the sensor. Sensing the preset input by the sensor is expressed as an occurrence of an event. In this case, a user directly inputs coordinates including numbers, etc. in order to preset the location to be monitored.

### SUMMARY

The present disclosure provides a method and device that can set up an operation according to an occurrence of an event without a device having a separate user interface. Further, the present disclosure provides a method and device that can set up an event using an image acquired by a monitoring device in cases where one sensor supports the occurrence of several events. In addition, the present disclosure provides a method and device that can set up an initial location of a monitoring operation and a monitoring device using an image acquired by the monitoring device.

In accordance with an aspect of the present disclosure, a method of a monitoring device connectable with a sensor device monitoring surroundings thereof is provided. The method includes searching for a sensor device; acquiring images for the surroundings of the monitoring device; registering location information corresponding to the sensor device, discovered through searching, using the images; and registering monitoring information including an operation performed in response to an event occurring in the discovered sensor device.

In accordance with another aspect of the present disclosure, a monitoring device connectable with a sensor device is provided. The monitoring device includes a camera configured to acquire an image; a communication unit configured to transmit/receive a signal in a wired or wireless manner; a storage unit configured to register information; and a controller configured to search for a sensor device, acquire images for the surroundings of the monitoring device, register location information corresponding to the sensor device, discovered through searching, using the images, and register monitoring information including an operation performed in response to an event occurring in the discovered sensor device.

In accordance with an aspect of the present disclosure, a chipset for a monitoring device connectable with a sensor device monitoring surroundings thereof is provided. The chipset is configured to search for a sensor device; acquire images for the surroundings of the monitoring device; register location information corresponding to the sensor device, discovered through searching, using the images; and register monitoring information including an operation performed in response to an event occurring in the discovered sensor device.

### BRIEF DESCRIPTION OF THE DRAWINGS

The above and other aspects, features, and advantages of the present disclosure will be more apparent from the following detailed description, taken in conjunction with the accompanying drawings, in which:

FIG. 1 illustrates a configuration of a system including a monitoring device and a sensor device according to an embodiment of the present disclosure;

FIG. 2 is a flowchart of a method in which a monitoring device connectable with a sensor device monitors the surroundings thereof according to an embodiment of the present disclosure;

FIG. 3 is a flowchart of a method of registering location information based on an image according to an embodiment of the present disclosure;

FIG. 4 is a flowchart of a method of registering location information based on an area according to an embodiment of the present disclosure;

FIG. 5 is a flowchart of a method of registering location information based on a preset form according to an embodiment of the present disclosure;

FIG. 6 is a block diagram of a monitoring device according to an embodiment of the present disclosure;

FIG. 7 is a flow diagram of information transfer in cases where an input unit and a display unit of a monitoring device are implemented as a separate touch screen according to an embodiment of the present disclosure;

FIG. 8 is a flowchart of a method of automatic registration of a sensor location and an event according to an embodiment of the present disclosure;

FIGS. 9A and 9B illustrate images for the surroundings of a monitoring device;

FIG. 10 is a flowchart of a method of registering multiple events according to an embodiment of the present disclosure;

FIG. 11 illustrates an event list supported by a sensor device according to an embodiment of the present disclosure;

FIG. 12 illustrates an input for associating an area of a displayed image with an event according to an embodiment of the present disclosure;

FIG. 13 is a flowchart of a time control process in cases where a plurality of locations match a single event according to an embodiment of the present disclosure; and

FIG. 14 illustrates monitoring time control through an image comparison according to an embodiment of the present disclosure.

### DETAILED DESCRIPTION OF EMBODIMENTS OF THE PRESENT DISCLOSURE

The term “comprise” used in the present disclosure and the appended claims does not mean excluding other elements or operations. Singular nouns used in the present disclosure and the appended claims include plural nouns unless the context clearly indicates otherwise. For instance, the term “sensor device” may indicate one sensor, or may include two or more sensors. Also, the term “image” may indicate one or more images, or may include one or more videos. The suffix “unit” used to indicate an element in present disclosure and the appended claims is introduced or used interchangeably only for the purpose of description of the present disclosure and thus does not provide a unique meaning or a function distinguished from each other.

The term “event” used in the present disclosure and the appended claims indicates sensing, by a sensor device, an input in a preset range. According to an embodiment of the present disclosure, it may be defined as an occurrence of an event that a sensor device including a temperature sensor measures a temperature of 45 degrees Celsius or more.

The term “location information” used in the present disclosure and the appended claims may include a relative location, coordinates, or an area with respect to a monitoring device. The coordinates may be displayed in the form of a pan, a tilt, and a zoom of a camera of the monitoring device. The area may correspond to a partial section of a panoramic image. The location may include the coordinate or area.

The term “monitoring information” used in the present disclosure and the appended claims may include a condition under which a sensor device generates an event, and an operation that a monitoring device performs when the event occurs.

Hereinafter, various embodiments of the present disclosure will be described with reference to the accompanying drawings. In the following description, only parts required to understand operations according to embodiments of the present disclosure will be described and a description of other parts will be omitted so as not to obscure the subject matter of the present disclosure. In this case, the features of the present disclosure are not limited to the above described examples, but may cover modifications in form and additional functions of each element, which are described below. In the accompanying drawings, the size of a few elements may be enlarged for illustration purposes, and may not be illustrated in proportion to the size.

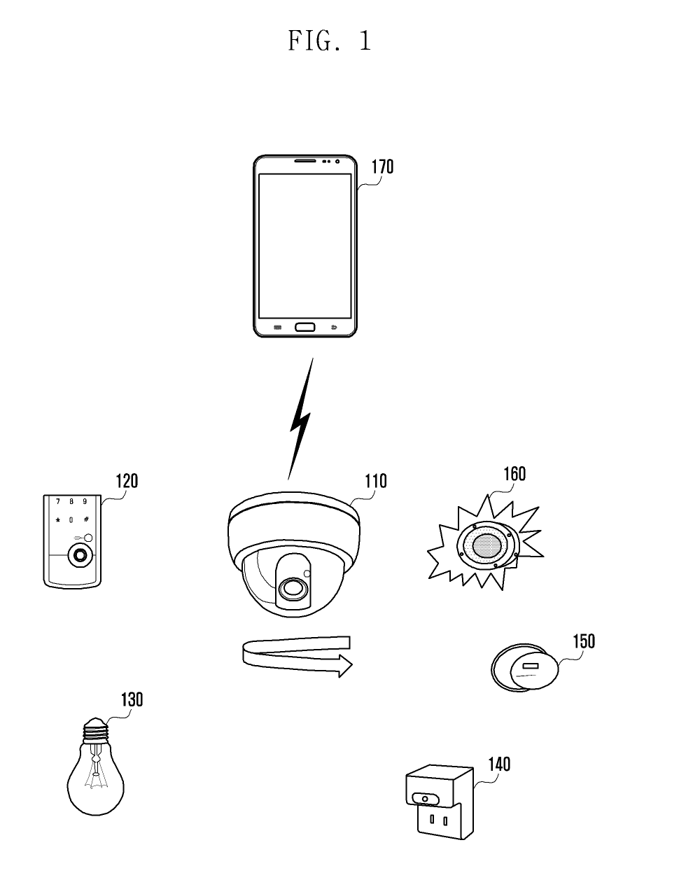

FIG. 1 illustrates a configuration of a system including a monitoring device and a sensor device according to an embodiment of the present disclosure.

Referring to FIG. 1, the monitoring device 110 may include a camera to take photographs while rotating therearound. Accordingly, the monitoring device 110 may acquire images of sensor devices 120, 130, 140, 150, 160 located therearound. In cases where the monitoring device 110 is indoors, the monitoring device 110 is typically on the ceiling, but is not limited thereto. The five sensor devices 120, 130, 140, 150, and 160 are illustrated in FIG. 1, but the present disclosure is not limited thereto. According to an embodiment of the present disclosure, the monitoring device 110 may acquire device information of the sensor devices 120, 130, 140, 150, and 160 therearound based on information on light sources (e.g., light emitting diodes (LEDs)) emitted from the sensor devices 120, 130, 140, 150, and 160 therearound.

The sensor devices 120, 130, 140, 150, and 160 may include, for example, a terrestrial magnetism sensor, a temperature sensor, an atmospheric pressure sensor, a proximity sensor, an illumination sensor, a global positioning system (GPS), an acceleration sensor, a motion sensor, an angular-velocity sensor, a speed sensor, a gravity sensor, a tilt sensor, a gyro sensor, or the like, but are not limited to the enumerated examples. The sensor devices 120, 130, 140, 150, and 160 may transfer identifiers including their device information to an external device through wireless communication or a light-source information display (e.g., an LED).

The monitoring device 110 may include separate user equipment 170 having an input unit and a display unit. The user equipment 170 may include a display constituted with one or more touch screens and may correspond to an electronic device configured to display content (e.g., images). For example, the user equipment 170 may correspond to a personal computer (PC), a portable multimedia player (PMP), a personal digital assistant (PDA), a smart phone, a cellular phone, or a digital picture frame. Also, the user equipment 170 may correspond to a dedicated device for the monitoring device 110. The user equipment 170 may transmit/receive data to/from the monitoring device 110 through a wired or wireless connection therebetween. Although the monitoring device 110 is illustrated as including the separate user equipment 170 in FIG. 1, the present disclosure is not limited thereto, and one physical device may also be implemented to include all of the camera, the input unit, and the display unit.

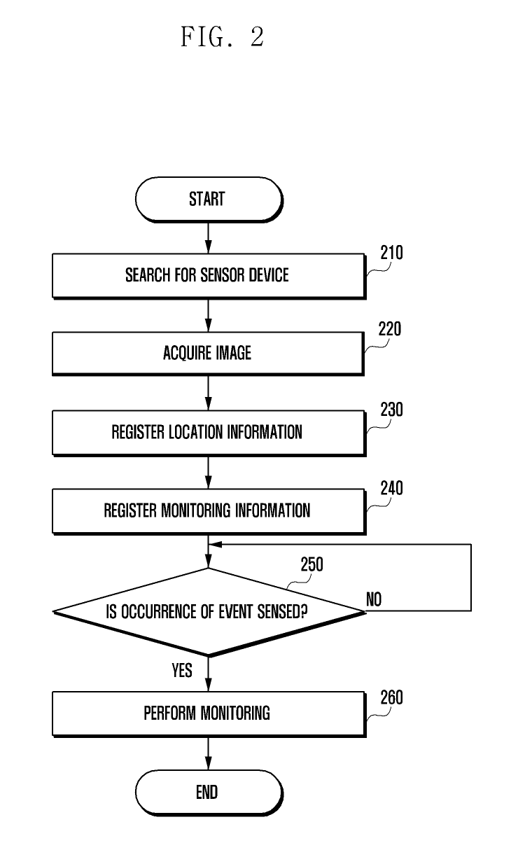

FIG. 2 is a flowchart of a method in which a monitoring device connectable with a sensor device monitors the surroundings thereof according to an embodiment of the present disclosure.

Referring to FIG. 2, in step 210, the monitoring device searches for a sensor device therearound. A signal or light emitted from the sensor device may be used in the search. For example, the monitoring device may recognize the presence of the sensor device and acquire device information of the sensor device based on a wired/wireless communication with the sensor device or information on a light source emitted from the sensor device. In contrast, the monitoring device may also receive information on the sensor device therearound from an external server.

In step 220, the monitoring device acquires images of the surroundings thereof using a camera. In cases where the monitoring device has one camera, the camera may take photographs while rotating therearound 360 degrees. In cases where the monitoring device has three cameras sharing the same rotation center, each of the cameras may take photographs while rotating therearound 120 degrees. In cases where the monitoring device has a plurality of cameras with different rotation centers, each of the cameras may take photographs while rotating therearound 360 degrees. Photographing may correspond to at least one of capturing a still image and filming a video.

In step 230, using the acquired images, the monitoring device registers location information corresponding to the sensor device discovered through the search. The registered location information may include information on where the monitoring device performs monitoring when an event occurs by the discovered sensor device.

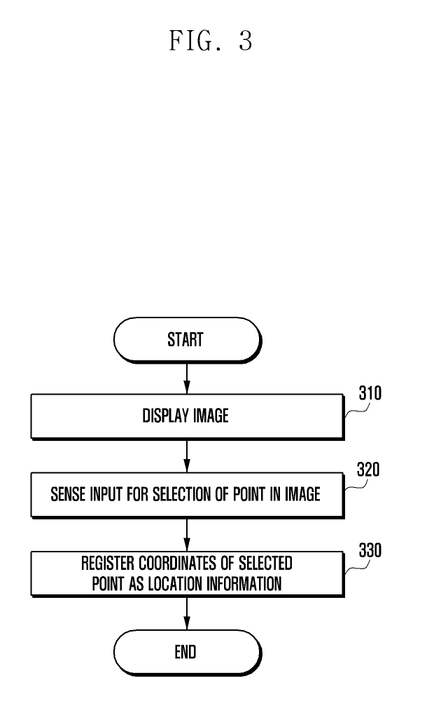

FIG. 3 is a flowchart of a method of registering location information based on an image according to an embodiment of the present invention.

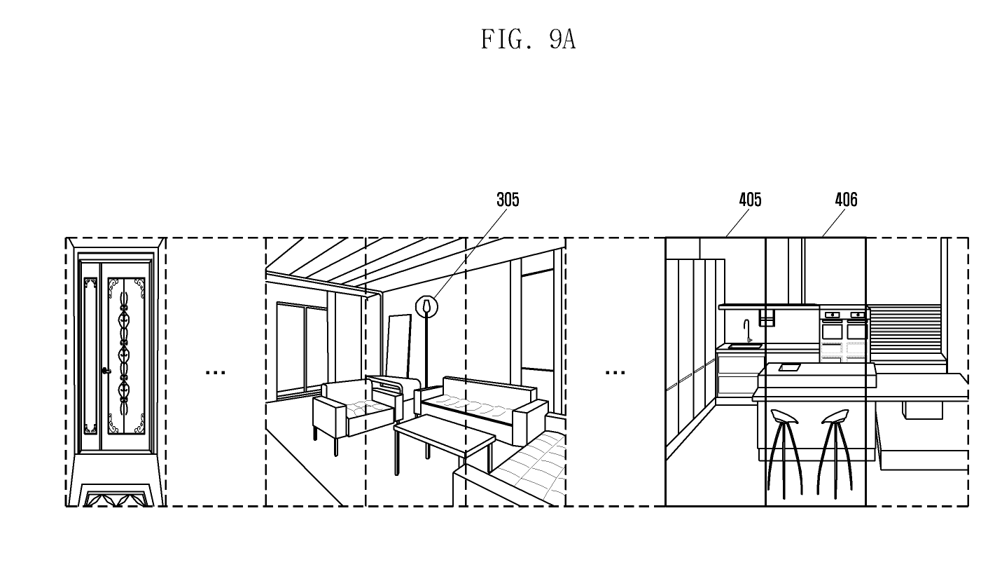

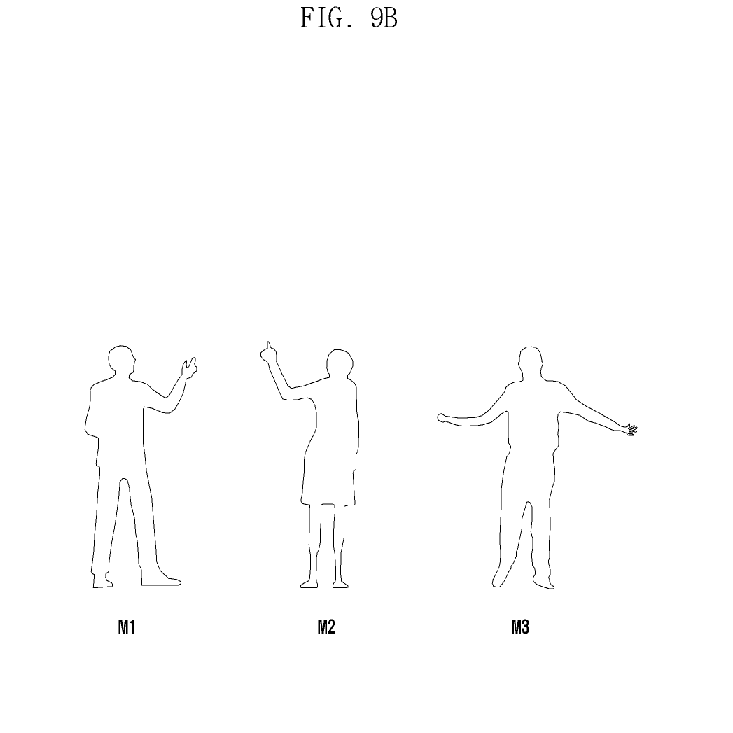

Referring to FIG. 3, in step 310, the monitoring device displays the acquired images on a display unit thereof. Examples of images are illustrated in FIG. 9A. FIG. 9A illustrates images of a front door, a living room, and a kitchen in a house, which are acquired by the camera of the monitoring device. Although the images are displayed in a plurality of subdivided areas in FIG. 9A, the present disclosure is not limited thereto. Meanwhile, in FIG. 9A, the areas are distinguished from each other based on a pan of the camera. However, the areas may also be distinguished from each other based on a tilt of the camera.

In FIG. 3, in step 320, the monitoring device senses an input for selecting at least one point in the displayed images. For example, in cases where the display unit of the monitoring device is a touch screen, the monitoring device senses a touch input on an item indicated by reference numeral “305” in FIG. 9A.

In FIG. 3, in step 330, the monitoring device registers the coordinates of the selected point as location information corresponding to the sensor device. The coordinates may correspond to the orientation of the camera of the monitoring device. For example, the coordinates may correspond to Pan=120°, Tilt=10°, and Zoom=1.

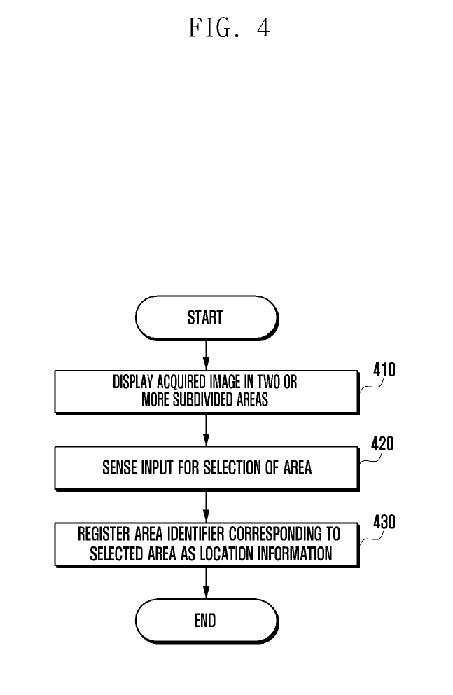

FIG. 4 is a flowchart of a method of registering location information based on an area according to an embodiment of the present disclosure.

Referring to FIG. 4, in step 410, the monitoring device displays the acquired images in two or more subdivided areas. Examples of the images are illustrated in FIG. 9A.

In step 420, the monitoring device senses an input for selecting at least one of the displayed areas. For example, the monitoring device may sense an input for selecting an area 405 or an input for selecting areas 405 and 406 in FIG. 9A.

In FIG. 4, in step 430, the monitoring device registers an area identifier corresponding to the selected area, as location information corresponding to the sensor device. Each area in FIG. 9A may have a unique area identifier. For example, assuming that the sensor identifier of the sensor device discovered through the search is S1 and the area identifier of area 405 is L1, the monitoring device may register L1 as location information of S1.

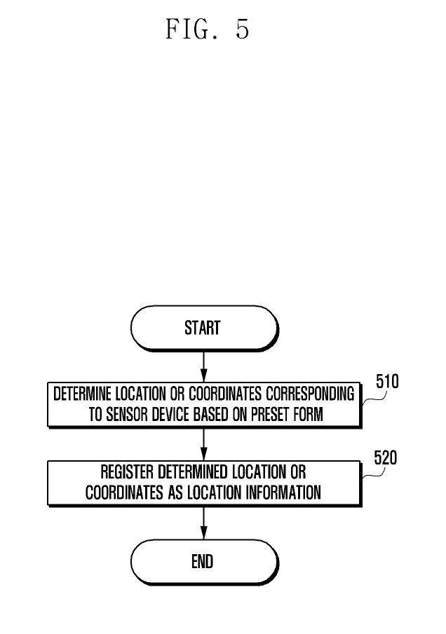

FIG. 5 is a flowchart of a method of registering location information based on a preset form according to an embodiment of the present disclosure.

Referring to FIG. 5, in step 510, the monitoring device determines a location or coordinates corresponding to the sensor device based on a preset form incorporated in the acquired images. The preset form may correspond to, for example, a person's motion or a certain shape of a diagram emitted through an LED of an external device. FIG. 9B illustrates examples of a person's motion. The monitoring device may determine the location or coordinates corresponding to the sensor device through a direction indicated by a person's hand or an angle of the person's face included in the acquired images. In FIG. 5, in step 520, the monitoring device registers the determined location or coordinates as location information corresponding to the sensor device.

Various embodiments of an operation of registering location information have been described above with reference to FIGS. 3 to 5. In FIG. 2, in step 240, the monitoring device registers monitoring information after the registration of the location information. The monitoring information may include an operation performed in response to an event occurring in the discovered sensor device. In cases where the registered location information includes a plurality of locations, areas, or coordinates, the monitoring device may include a monitoring time configured for each location, area, or coordinate in the monitoring information. In FIG. 5, the monitoring device may determine an operation based on at least one of a motion, a color, and a pattern included in a preset form and may register the determined operation.

Although the monitoring information is registered after the location information in the above description, the location information may also be registered after the monitoring information, or the monitoring information and the location information may also be simultaneously registered, without being limited thereto. After registering the location information and the monitoring information, the monitoring device determines, in FIG. 2, in step 250, whether the occurrence of an event by the sensor device discovered through the search is sensed.

When the occurrence of the event is sensed, the monitoring device performs monitoring using the registered location information in step 260. The monitoring device may periodically acquire an image for each location (e.g., area or coordinate) while performing the monitoring, and may increase a corresponding monitoring time for a location (e.g., area or coordinate) where the change of an image is sensed.

The monitoring device may perform a calculation by accumulating the monitoring time for each location (e.g., area or coordinate). While not performing the monitoring, the monitoring device may set the direction of the camera of the monitoring device such that the camera is oriented toward the location (e.g., area or coordinate) having the longest monitoring time accumulated.

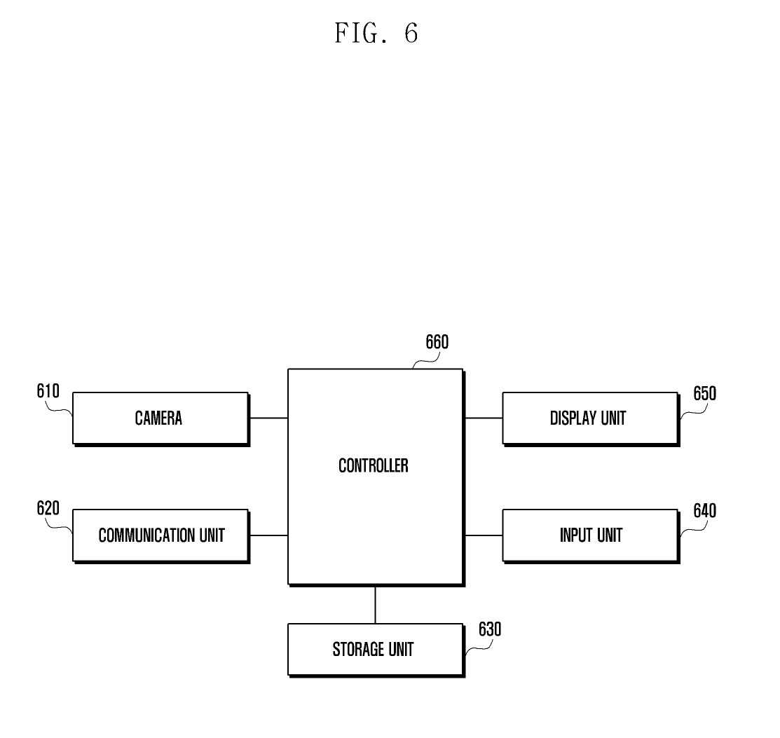

FIG. 6 is a block diagram of a monitoring device according to an embodiment of the present disclosure.

Referring to FIG. 6, the monitoring device may include a camera 610, a communication unit 620, a storage unit 630, an input unit 640, a display unit 650, and a controller 660.

The camera 610 may acquire images of the surroundings of the monitoring device. The images may correspond to one or more still images or videos.

The communication unit 620 may transmit/receive a signal in a wired or wireless manner. The communication unit 620 may search for a sensor device by receiving a signal or light.

The storage unit 630 may register an application program corresponding to a function performed by the monitoring device and information generated while the function is performed in the monitoring device.

The input unit 640 senses a user input and transfers the same to the controller 660. The display unit 650 may display the entirety or a portion of an image. The display unit 650 may display a scroll bar together when displaying only a portion of an image. The input unit 640 may be formed as a touch screen in combination with the display unit 650, or may be formed as a typical keypad. In addition, the input unit 640 may be configured as a function key, a soft key, or the like which is selected in order to perform a function. The monitoring device may have the input unit 640 and display unit 650 in the form of separate user equipment, and the input unit 640 and the display unit 650 may transmit/receive a signal to/from the other units of the monitoring device in a wired or wireless manner.

The controller 660 controls overall states and operations of the components constituting the monitoring device. The controller 660 may perform event management, device control, image comparison, streaming, capturing, and the like in order to register information and perform monitoring.

Although it has been described in FIG. 6 that the camera 610, the communication unit 620, the storage unit 630, the input unit 640, the display unit 650, and the controller 660 are configured as separate components which perform different functions, this is only for convenience of description, and the functions are not necessarily differentiated from each other as described above.

For example, the controller 660 may search for a sensor device, acquire images for the surroundings of the monitoring device, register location information corresponding to the sensor device discovered through the search using the images, register monitoring information including an operation performed in response to an event occurring in the discovered sensor device, and perform monitoring using the registered location information when sensing the occurrence of the event caused by the discovered sensor device. The location information corresponding to the discovered sensor device may include information on where the monitoring device monitors according to the occurrence of the event caused by the discovered sensor device.

In addition, the controller 660 may display the acquired images, sense an input for selecting at least one point included in the displayed images, and register the coordinates of the selected point as the location information corresponding to the sensor device. Furthermore, the controller 660 may display the acquired images in two or more subdivided areas, sense an input for selecting at least one of the displayed areas, and register an area identifier corresponding to the selected area as the location information corresponding to the sensor device. Also, the controller 660 may determine the location or coordinates corresponding to the sensor device on the basis of a preset form included in the acquired images and register the location or coordinates as the location information corresponding to the sensor device. In this case, the controller 660 may determine an operation performed in response to an event occurring in the sensor device based on at least one of a motion, a color, and a pattern included in a preset form and register the determined operation.

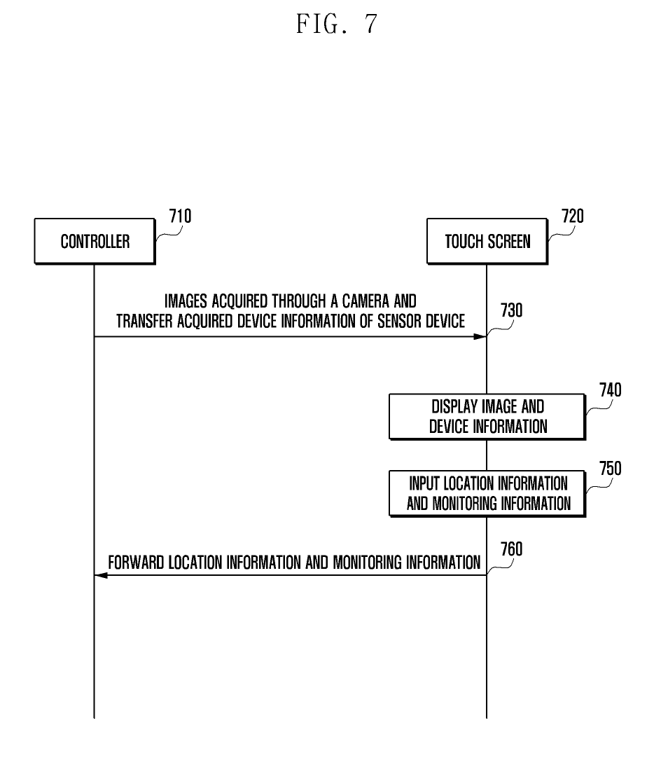

FIG. 7 is a flow diagram of information transfer in cases where an input unit and a display unit of a monitoring device are implemented as a separate touch screen according to an embodiment of the present disclosure.

Referring to FIG. 7, a controller 710 is connected with a touch screen 720 in a wired or wireless manner to exchange a signal therebetween.

In step 730, the controller 710 transfers images acquired through a camera and device information of a sensor device acquired through a communication unit to the touch screen 720. The images may correspond to a panoramic image obtained by photographing the surroundings of the monitoring device while rotating the camera 360 degrees.

In step 740, the touch screen 720 may display the transferred images and device information in such a manner that a user can access.

In step 750, the user may input location information corresponding to the sensor device and monitoring information based on the displayed images and device information. The monitoring information may include an operation performed in response to an event occurring in the sensor device.

In step 760, the touch screen 720 may forward the input location information and the monitoring information to the controller 710.

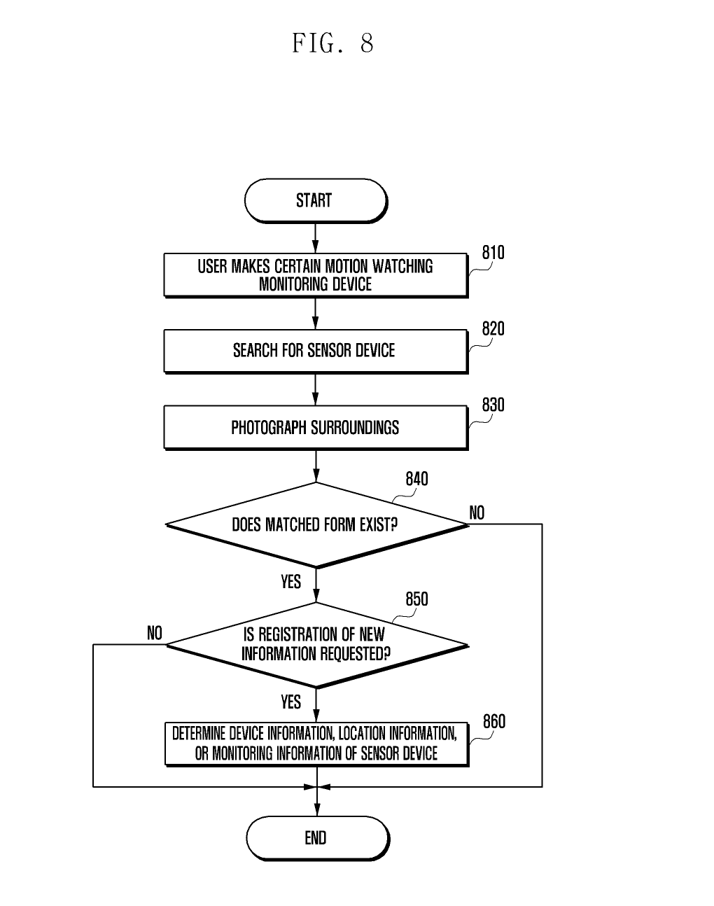

FIG. 8 is a flowchart of a method of automatic registration of a sensor location and an event according to an embodiment of the present disclosure.

Referring to FIG. 8, in step 810, a user may make a certain motion while viewing a monitoring device. Alternatively, a sensor device may generate light in a preset color or in a preset blinking pattern.

In step 820, the monitoring device searches for a sensor device. In the search process, the monitoring device may acquire device information (including a sensor identifier) of the sensor device on the basis of the signal or light transmitted by the sensor device.

In step 830, the monitoring device acquires images (e.g., images or a video) by photographing the surroundings thereof. In cases where the monitoring device has one camera, the camera may take photographs while rotating 360 degrees. The images or video acquired by photographing may be shared with another monitoring device. In addition, the monitoring device may have a plurality of cameras, in which case the cameras may photograph the surroundings in cooperation with each other. For example, in cases where there are two cameras rotating about the same point, each camera may take photographs in a range of 180 degrees.

FIGS. 9A and 9B illustrate images for the surroundings of the monitoring device.

Referring to FIG. 9A, images taken by the camera of the monitoring device may be divided into two or more areas. For convenience, the images are divided into nine areas in FIG. 9A.

Referring to FIG. 9B, images taken by the camera of the monitoring device may include a preset-form. FIG. 9B illustrates people's motions corresponding to examples of pre-set forms. For convenience, the respective motions are defined as M1, M2, and M3.

In FIG. 8, in step 840, the monitoring device determines whether a form matching that included in the acquired images has been stored in a storage unit. The form may include, but is not limited to, a person's shape, motion, or face, or color of light or a blinking pattern. When it is determined that the matched form has been stored in the storage unit, the monitoring device proceeds to step 850.

In step 850, the monitoring device determines whether the registration of new information corresponding to the matched form has been requested. When it is determined that the registration of the information has been requested, the monitoring device proceeds to step 860. In contrast, unlike in FIG. 8, even though there is no request for registering new information, if the matched form has been stored in the storage unit, the monitoring device may also be implemented to proceed to step 860. In this case, information to be determined in step 860 may be automatically determined and registered without a user input.

In step 860, the monitoring device determines device information, location information, or monitoring information of the sensor device. The device information may correspond to a universally unique identifier (UUID) or an internet protocol (IP) address of the sensor device responsive to the search. The location information may include information on a pan, a tilt, or a zoom of the camera. The location information may be determined in view of an angle of a user's face. The monitoring information may be determined in view of the user's motion.

Table 1 below represents a correspondence relation between an operation included in monitoring information and location information.

TABLE 1

| Sensor | | | | |
|---|---|---|---|---|
| Identifier | Motion | Pan | Tilt | Zoom |
| S1 | Capture | 30 | 10 | 1 |
| S2 | Capture | 120 | 0 | 0 |
| S3 | Streaming | 180 | −10 | 0 |
| | (1 minute) | | | |

Table 1 above shows matching relations between a form (e.g. a persons' motion), a sensor identifier, an operation included in monitoring information, and a direction (e.g., pan, tilt, and zoom) of a camera. In Table 1 above, “capture” indicates acquiring a still image while performing monitoring, and “streaming” indicates displaying, on a display unit of the monitoring device, a video acquired while performing monitoring. According to an embodiment of the present disclosure, the storage unit of the monitoring device may store the form, the operation, and the direction of the camera by matching them, and when the form included in the acquired images matches that stored in the storage unit, the storage unit may determine location information or monitoring information corresponding to a sensor based on the operation and the direction of the camera which match the form.

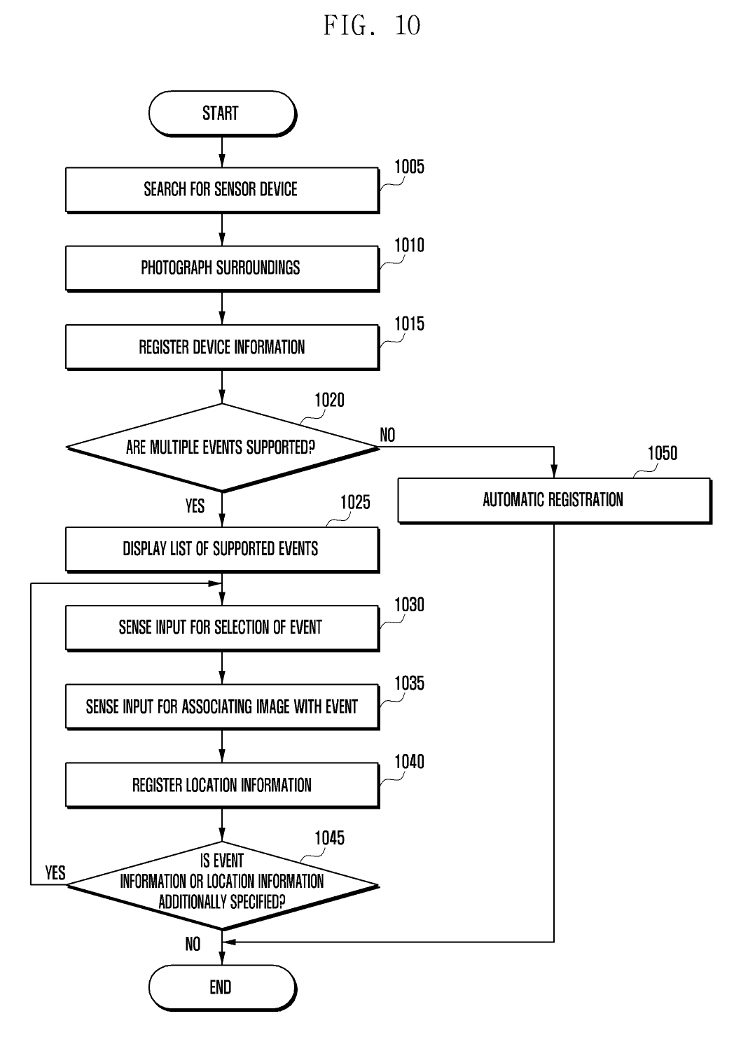

FIG. 10 is a flowchart of a method of registering multiple events according to an embodiment of the present disclosure.

Referring to FIG. 10, a monitoring device searches for a sensor device in step 1005 and separately photographs the surroundings thereof in step 1010. Steps 1005 and 1010 may also be simultaneously performed.

In step 1015, the monitoring device may register device information of a sensor device responding to the search. The device information may correspond to a UUID or an IP address of the sensor device responding to the search.

In step 1020, the monitoring device may determine whether the sensor device responding to the search supports multiple events. When it is determined that the sensor device responding to the search supports multiple events, the monitoring device may proceed to step 1025 to display a list of the events supported by the sensor device responding to the search.

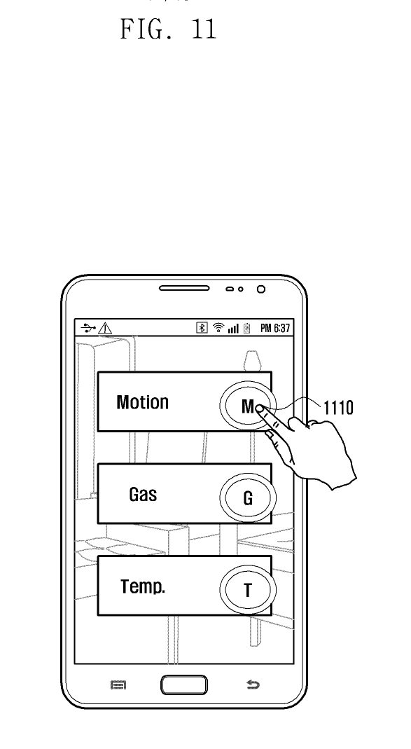

FIG. 11 illustrates an event list supported by the sensor device according to an embodiment of the present disclosure.

Referring to FIG. 11, a list including three events is displayed. In FIG. 11, the list including a motion event, a gas event, and a temperature event is displayed, and the image captured in step 1010 is displayed as the background of the list. The motion event indicates to sense the intrusion of an outsider, the gas event indicates to sense the leakage of gas, and the temperature event indicates to sense the outbreak of a fire.

In step 1030, the monitoring device may sense an input for selecting an event from the displayed list. For example, a long press 1110 in FIG. 11 may correspond to the input. According to an embodiment of the present disclosure, when an event is selected, the list may disappear, and the image captured in step 1010 of FIG. 10 may be displayed. In this case, the displayed image may be the entirety of the image captured in step 1010, or may also be a part of the captured image in view of the size of a display unit. In cases where the monitoring device displays only a part of the image captured in step 1010, the monitoring device may display a scroll bar and display the rest of the image using the scroll bar. In step 1035, the monitoring device may sense an input for associating the displayed image with the event.

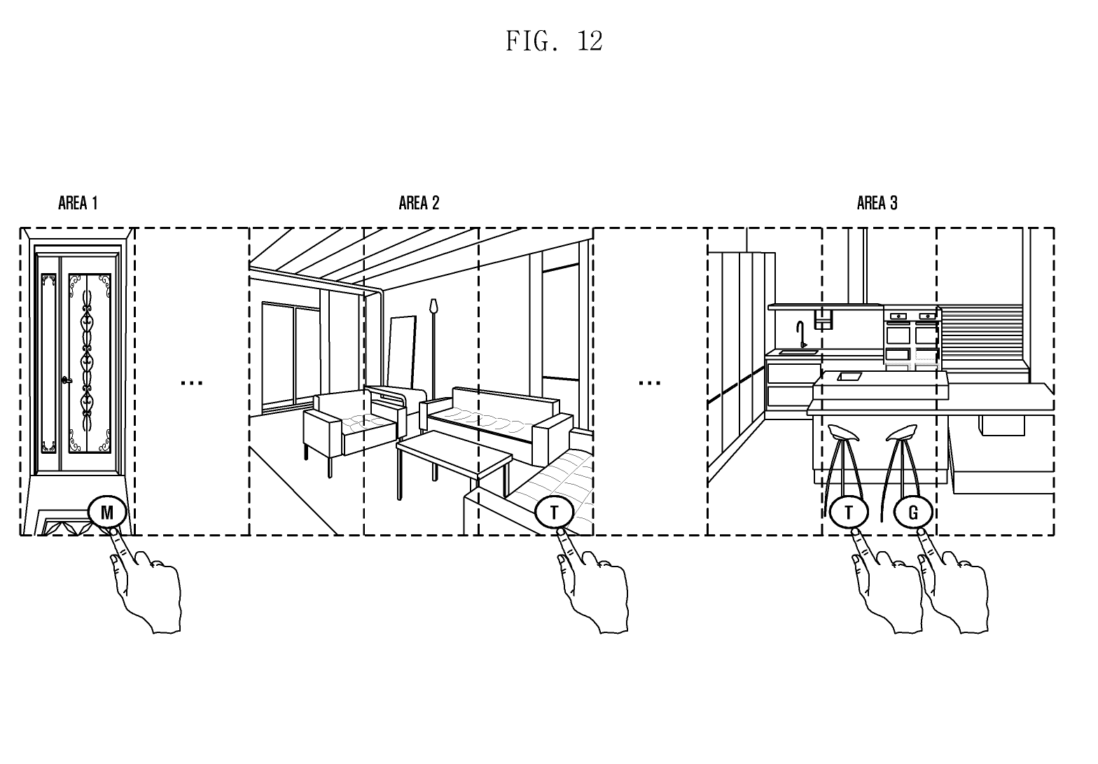

FIG. 12 illustrates an input for associating an area of a displayed image with an event according to an embodiment of the present disclosure.

Referring to FIG. 12, an input for associating an area of a displayed image with an event may correspond to the release of a long press in a desired area of the displayed image. However, the input for associating an area of a displayed image with an event is not limited to the release operation. For example, all the inputs in steps 1030 and 1035 of FIG. 10 may correspond to short presses or clicks. In FIG. 12, the motion (M) event is associated with AREA 1 on the image, the temperature (T) event is associated with AREA 2 on the image, and the temperature (T) event and the gas (G) event are associated with AREA 3 on the image. In this case, since the temperature (T) event is associated with two areas (e.g., a living room and a kitchen), monitoring may be performed on both AREA 2 and AREA 3 when a temperature event occurs.

In FIG. 10, in step 1040, the monitoring device registers the location information of the sensor device based on the event-associated area on the image. The location information may include information on a pan, a tilt, or a zoom of a camera of the monitoring device.

In step 1045, the monitoring device determines whether to additionally specify event information or location information. When receiving an input of additional specification, the monitoring device may proceed to step 1030 and may specify a plurality of pieces of event information or location information according to the repetition of the additional specification. In this case, the monitoring device may repetitively specify only one of the event information and the location information, in which a plurality of events and a single location or a single event and a plurality of locations may match each other.

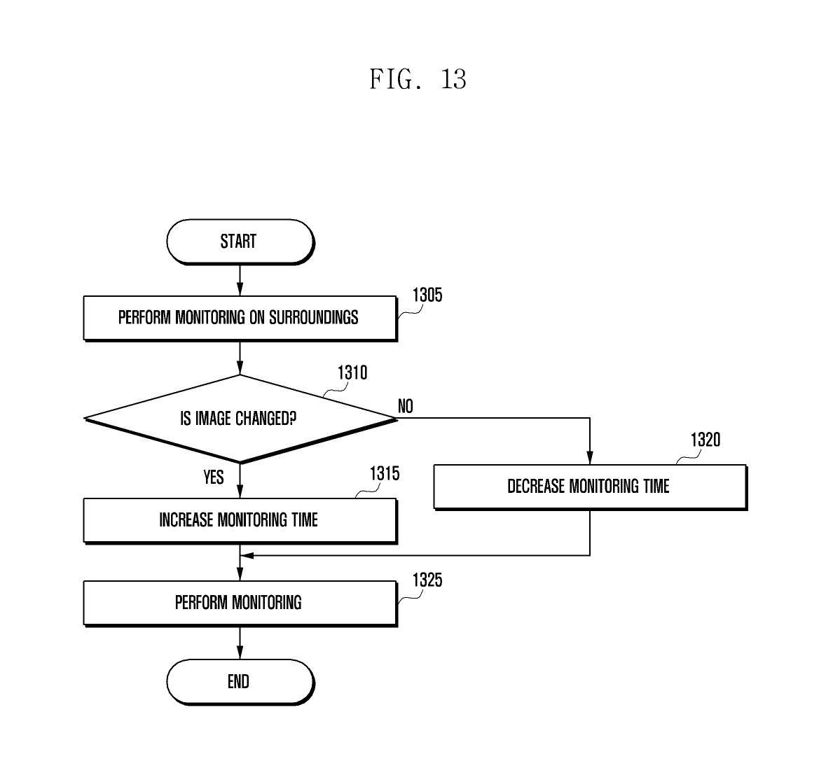

FIG. 13 is a flowchart of a time control process in cases where a plurality of locations match a single event according to an embodiment of the present disclosure.

Referring to FIG. 13, in step 1305, when an event occurs in a sensor device, a monitoring device monitors the surroundings thereof. In cases where the monitoring is performed on a plurality of locations, a monitored location may change every predetermined time. Furthermore, every time monitoring is initiated or terminated for each monitored location, an image may be acquired through photographing and stored. The image may include a video.

In step 1310, the monitoring device may compare the image captured at each location with an image captured in the previous cycle to determine whether there is a difference therebetween. When it is determined that there is a difference therebetween, the monitoring device may increase a monitoring time for the corresponding location in step 1315. In contrast, when it is determined that there is no difference therebetween, the monitoring device may decrease a monitoring time for the corresponding location in step 1320.

In step 1325, the monitoring device performs monitoring based on the increased or decreased time. Alternatively, unlike in steps 1315 and 1320, the monitoring device may also maintain the monitoring time. Furthermore, the monitoring device may also include the number of locations where an image is changed in the standard for changing the monitoring time. For example, in the case of monitoring two locations, if all images for the two locations are changed, the monitoring device may maintain the monitoring time for both locations as it is, or may increase the monitoring time. In addition, a user may also increase only the monitoring time for a preset location. The monitoring time may have a maximum threshold and a minimum threshold, and may be configured to be varied between the maximum threshold and the minimum threshold.

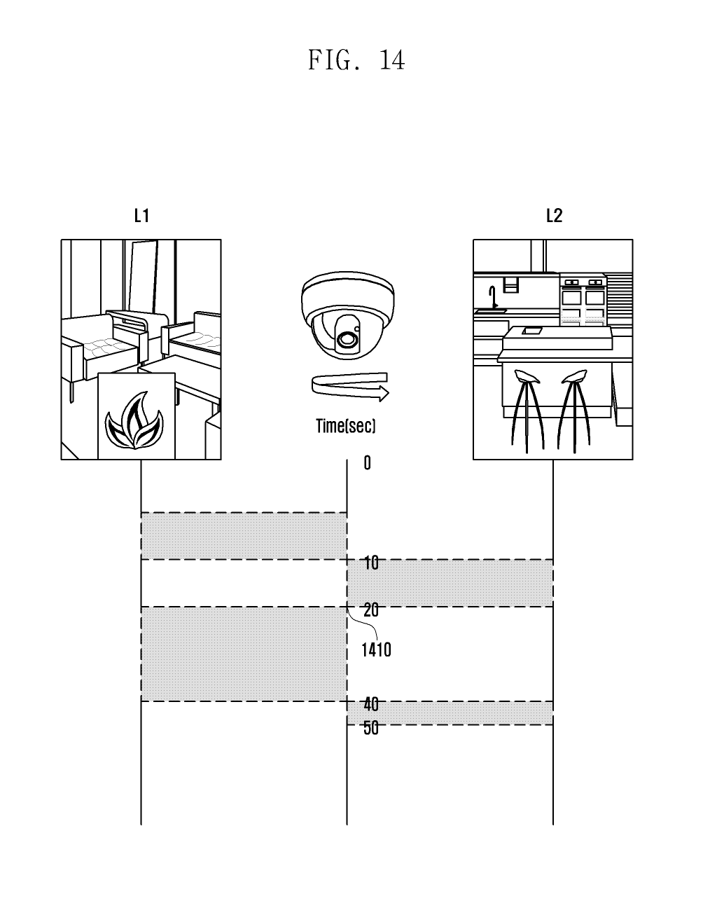

FIG. 14 illustrates monitoring time control through an image comparison according to an embodiment of the present disclosure.

Referring to FIG. 14, a monitoring device perceives a change of an image at 1410 and thereafter increases a monitoring time for L1 from 10 seconds to 20 seconds. In contrast, the monitoring device decreases a monitoring time for L2, where an image is not changed, from 10 seconds to 5 seconds.

When the monitoring device changes the monitoring time in step 1315 or step 1320 in FIG. 13, the monitoring device performs the monitoring by applying the changed monitoring time in step 1325. According an embodiment of the present disclosure, even though an image is changed, the monitoring device may also perform monitoring without changing a monitoring time.

An event operating time may be set separately from the monitoring time. That is, the monitoring time may be set to occur until the event operating time lapses after an event occurs. For example, in cases where a monitoring time for two locations is set to 10 seconds and an event operating time is set to 100 seconds, if there is no change in monitoring time, monitoring is performed on the two places for 50 seconds and then terminated.

Table 2 below is a chart relating to determining the initial direction of a camera in view of a monitoring frequency.

TABLE 2

| | Sensor | Monitoring frequency | Monitoring frequency |
|---|---|---|---|
| Location | ID | for each sensor | for each location |
| L1 | S1 | 35(23.3%) | 40.0% |
| | S2 | 25(16.7%) | |
| L2 | S1 | 40(26.7%) | 26.7% |
| L3 | S1 | 20(13.3%) | 13.3% |
| L4 | S3 | 30(20.0%) | 20.0% |

Referring to Table 2 above, sensors S1 and S2 correspond to location L1. The monitoring device, while not performing monitoring, may set the camera to be oriented toward L1 with the highest monitoring frequency for each location of 40.0%. Accordingly, the camera initially faces the direction in which monitoring is most likely to be performed when an event occurs, which leads to a reduction in initial time for performing monitoring in response to an event. Although the initial direction of the camera is determined based on the monitoring frequency, the initial direction of the camera may be alternatively determined based on the accumulated monitoring time. For example, the monitoring device may set the camera to be oriented toward a location with the longest accumulated monitoring time.

Although certain embodiments have been described and illustrated in the present disclosure and the accompanying drawings, these are provided merely to describe and to facilitate a thorough understanding of the present invention, and are not intended to limit the scope of the present disclosure. Therefore, it should be construed that all modifications of the present disclosure are included within the scope of the present disclosure as defined by the appended claims, and their equivalents.

What is claimed is:

1. A method of a monitoring device connectable with a sensor device monitoring surroundings thereof, the method comprising:
searching for a sensor device;
acquiring images for the surroundings of the monitoring device;
registering location information corresponding to the sensor device, discovered through searching, using the images; and
registering monitoring information including an operation performed in response to an event occurring in the discovered sensor device.

2. The method of claim 1, further comprising:
monitoring the surroundings of the monitoring device using the registered location information when the occurrence of the event by the discovered sensor device is sensed.

3. The method of claim 1, wherein the location information corresponding to the discovered sensor device comprises information on a location that the monitoring device monitors according to the occurrence of the event by the discovered sensor device.

4. The method of claim 1, wherein registering location information comprises:
displaying the acquired images;
sensing an input for selecting at least one point contained in the displayed images; and
registering coordinates of the selected at least one point as the location information corresponding to the sensor device.

5. The method of claim 1, wherein registering location information comprises:
displaying the acquired images in at least two subdivided areas;
sensing an input for selecting at least one of the displayed at least two subdivided areas; and
registering area identifiers of the selected at least one of the displayed at least two subdivided areas as the location information corresponding to the sensor device.

6. The method of claim 1, wherein registering location information comprises:
determining a location or coordinate corresponding to the sensor device based on a preset form included in the acquired images; and
registering the location or coordinate as the location information corresponding to the sensor device.

7. The method of claim 6, wherein registering monitoring information comprises:
determining the operation performed in response to the event occurring in the discovered sensor device based on at least one of a motion, a color, and a pattern incorporated in the preset form; and
registering the determined operation.

8. The method of claim 1, further comprising:
acquiring device information of the sensor device based on information on a light source emitted from the sensor device.

9. The method of claim 1, if the location information corresponding to the sensor device comprises a plurality of locations, areas, or coordinates, registering monitoring information comprises setting up monitoring times according to the locations, areas, or coordinates.

10. The method of claim 9, wherein the monitoring information comprises:
increasing a monitoring time corresponding to the plurality of locations, areas, or coordinates where a change is sensed.

11. The method of claim 9, further comprising:
accumulatively calculating monitoring times for each of the plurality of locations, areas, or coordinates; and
setting a camera included in the monitoring device to be oriented toward one of the plurality of locations, areas, or coordinates with a longest accumulated monitoring time when monitoring is not performed.

12. A monitoring device connectable with a sensor device, comprising:
a camera configured to acquire an image;
a communication unit configured to transmit/receive a signal in a wired or wireless manner;
a storage unit configured to register information; and
a controller configured to search for a sensor device, acquire images for the surroundings of the monitoring device, register location information corresponding to the sensor device, discovered through searching, using the images, and register monitoring information including an operation performed in response to an event occurring in the discovered sensor device.

13. The monitoring device of claim 12, wherein the controller is further configured to perform monitoring using the registered location information when the occurrence of the event by the discovered sensor device is sensed.

14. The monitoring device of claim 12, wherein the location information corresponding to the discovered sensor device comprises information on a location that the monitoring device monitors according to the event occurring in the discovered sensor device.

15. The monitoring device of claim 12, further comprising:
an input unit configured to sense a user input; and
a display unit configured to display an image,
wherein the controller is further configured to display the acquired images, sense an input for selecting one or more points contained in the displayed images, and register coordinates of the selected points as the location information corresponding to the sensor device.

16. The monitoring device of claim 12, further comprising:
an input unit configured to sense a user input; and
a display unit configured to display an image,
wherein the controller is further configured to display the acquired images in at least two subdivided areas, sense an input for selecting one or more of the displayed areas, and register area identifiers corresponding to the selected areas as the location information corresponding to the sensor device.

17. The monitoring device of claim 12, wherein the controller is further configured to determine a location or coordinate corresponding to the sensor device based on a preset form included in the acquired images, and register the location or coordinate as the location information corresponding to the sensor device.

18. The monitoring device of claim 17, wherein the controller is further configured to determine the operation performed in response to the event occurring in the discovered sensor device based on at least one of a motion, a color, and a pattern incorporated in the preset form and register the determined operation.

19. The monitoring device of claim 12, wherein the controller is further configured to acquire device information of the sensor device based information on a light source emitted from the sensor device.

20. The monitoring device of claim 12, if the location information corresponding to the sensor device comprises a plurality of locations, areas, or coordinates, the controller is further configured to set monitoring times according to the plurality of locations, areas, or coordinates.

21. The monitoring device of claim 20, wherein the controller is further configured to increase a monitoring time corresponding to the plurality of locations, areas, or coordinates where a change is sensed.

22. The monitoring device of claim 20, wherein the controller is further configured to accumulatively calculate monitoring times for each of the plurality of locations, areas, or coordinates, and set a camera to be oriented toward one of the plurality of locations, areas, or coordinates with a longest accumulated monitoring time when monitoring is not performed.

23. A chipset for a monitoring device connectable with a sensor device monitoring surroundings thereof, the chipset configured to:
search for a sensor device;
acquire images for the surroundings of the monitoring device;
register location information corresponding to the sensor device, discovered through searching, using the images; and
register monitoring information including an operation performed in response to an event occurring in the discovered sensor device.
